(19) United States
(12) Patent Application Publication
(10) Pub. No.: US 2011/0290872 A1
(43) Pub. Date: Dec. 1, 2011

(54) WRISTBAND OF ELONGATE NON SILICONE CONSTRUCTION

(76) Inventor: JERI D. BOCK, Santa Barbara, CA (US)

(21) Appl. No.: 13/151,222

(22) Filed: Jun. 1, 2011

Related U.S. Application Data
(60) Provisional application No. 61/350,468, filed on Jun. 1, 2010.

(51) Int. Cl. G06F 17/00; G09B 19/00; A41D 20/00

(52) U.S. Cl. 235/375; 2/170; 434/236

(57) ABSTRACT

A reminder wrist band of elongate material non silicone is disclosed. It is comprised of flexible material(s); elastic band, neoprene or alike, having a first end fixedly connected to a second end, the flexible material forms a continuous loop (band), at which point the reminder wrist band of elongate material is coupled together (stitched, glued, stapled, grommet, snapped or buttoned). The device acts as a visual reminder (much as the preverbal string around a finger). For some users the device may also provide a stress-reduction function, from its novel snapping mode of the elongate material (snapping or popping sound). Additionally, the reminder wrist band of elongate material may come with a tab. For instance, a piece of the flexible material would protrude past the overlapping connection point of the initial band (at the point the elongate material is coupled together, by any means of manufacturing) to create the tab.

### RELATED APPLICATIONS

This application claims the benefit under 35 U.S.C. §119 of U.S. Provisional application No. 61/350,468 filed on Jun. 1, 2010.

### FIELD OF THE INVENTION

The present invention is directed to a wristband and, in particular, to an elastic wristband on which graphics can be printed for use in training and memorization steps.

### BACKGROUND OF THE INVENTION

Elastic bands disclosed in prior art U.S. Patent class 132/273 in general and elastic bands for retaining hair in bundles are generally known in the prior art. Such elastic bands come in a great variety of shapes and sizes and include different features.

For example, U.S. Pat. No. 7,305,996 issued Dec. 11, 2007 to Kraft et al discloses an elastic band includes an elongate elastic core, a sheath, and an elongate friction member. The elongate elastic core comprising a continuous loop and the sheath has an outer surface and surrounds the elongate elastic core.

U.S. Pat. No. 6,516,637 issued Feb. 11, 2003 to Fancher, J. Von discloses a warp knit elastic band that includes at least one filler yarn knitted into the band on an outside surface. A method for manufacturing the elastic band is also disclosed in which at least one filler yarn is laid into the band adjacent either a back well yarn or a front well yarn on a side thereof opposite the elastomeric threads.

Wristbands and head bands are disclosed in prior art U.S. Patent class 40/633 as well as wristbands and head bands worn during sporting actives, such as tennis and basketball, etc. again, well known in prior art U.S. Patent class 2/170,171. Such bands are typically comprised of elastic terry cloth or alike. And fit the wearer's wrist or the upper portion of the user's head. Such bands are commonly worn to absorb perspiration.

For examples, U.S. Pat. No. D346,029 issued Apr. 12, 1994 to Shalvi, R. discloses the ornamental design for a wristband for relief of stress, as shown and described within the patent. And, U.S. Pat. No. 4,479,495 issued Oct. 30, 1984 to Isaacson, G. S. an acupressure device for applying continuous pressure to a specific spot on a human or an animal's body. Both disclosed in prior art U.S. Patent class 606/204.

Unlike the Shalvia, R. or Isaacson, G. S. wristband for relief of stress, a wristband of elongate material non silicone does not use pressure points but instead uses the “thought-stopping” procedure described in some physiatrist magazines, journals and/or self-help books, along with a breathing exercise, mantra and focusing on a goal to change a habit or create a new positive behavior.

### SUMMARY OF THE INVENTION

The primary object of a wristband of elongate material non silicone is to be used as a reminder/training tool. A wearer may use it for self-control training for relief of stressors in one's life i.e., the wearer would put a wristband of elongate material non silicone; (the wristband) on in the morning to remind him/her NOT to smoke all day. Watch what he/she eats for weight control; or to be reminded to do a breathing exercise before going to bed, for relaxation to help him/her far asleep more readily. Adult users may use the wristband as a self-control, stress-relief, training device, by elongating the wristband; pulling on the flexible material and/or attached tab; and releasing it; snapping mode; making a popping sound; while a child would be instructed to tap on the device three times, as a friendly reminder to calm him/herself before a stressful task, such a taking a test, to seek relief from test taking anxiety. In either case the user would then commence with a “thought-stopping” and/or breathing technique, mantra and focusing on a goal to change a habit or create a new positive behavior.

However, it is not limited to this sole purpose as another wearer may see fit to wear the wristband just as a decorative accessory, or to support a cause for fundraising. I.e.; “I Snap for Better Health” sponsored by local Food Bank. As it is my belief that the artwork to be printed (via sublimation) on the wristband will be very colorful and people will enjoy wearing the wristband.

In accordance with the disclosure, a wristband of elongate material non silicone is comprised of flexible material; elastic band, neoprene or alike, having a first end fixedly connected to a second end, the flexible material forms a continuous loop; band, which is either stitched, glued, stapled, grommet, snapped or buttoned for coupling. Additionally, the wristband may have a tab; An overlapping part of the flexible material would protrude past the connection point of the first and second ends, at which point the elongate material is coupled together to form a band with a tab.

The device will act as a visual reminder on a user's wrist to perform a stress-reduction exercise; as needed; after elongating the wristband against one's wrist and releasing it; snapping for adults and tapping for children. Sizes and shapes will vary depending on the dimensions to the approximate wrist size of a wearer, and printed artwork.

A reminder wrist band of elongate material non silicone is disclosed. It is comprised of flexible material(s); elastic band, neoprene or alike, having a first end fixedly connected to a second end, the flexible material forms a continuous loop (band), at which point the reminder wrist band of elongate material is coupled together (stitched, glued, stapled, grommet, snapped or buttoned). The device acts as a visual reminder (much as the preverbal string around a finger). For some users the device may also provide a stress-reduction function, from its novel snapping mode of the elongate material (snapping or popping sound). Additionally, the reminder wrist band of elongate material may come with a tab. For instance, a piece of the flexible material would protrude past the overlapping connection point of the initial band (at the point the elongate material is coupled together, by any means of manufacturing) to create the tab.

A further understanding of the nature and advantages of the invention will become apparent by reference to the remaining portions of the specification and drawings.

### BRIEF DESCRIPTION OF THE DRAWINGS

Features and advantages of the present invention will become appreciated as the same become better understood with reference to the specification, claims, and appended drawings wherein:

FIG. 1 is a top plan view of an exemplary wristband;

FIG. 2 is a front view of the wristband of elongate material non silicone shown coupled together with stitching;

FIG. 3 is a top plan view of an exemplary wristband with a tab;

FIG. 4 is a front view of the wristband of elongate material non silicone (with a tab) shown coupled together with stitching;

FIG. 5 is a perspective view of the wristband of elongate material non silicone elongated on a user's left wrist; and

FIG. 6 is a perspective view of the wristband of elongate material non silicone, elongated on a user's wrist, by pulling (stretching out) and releasing tab away from user's wrist (making snapping or popping sound) thereof;

### DETAILED DESCRIPTION OF THE PREFERRED EMBODIMENTS

The present disclosure relates generally to that of wrist/heads bands. However, the materials for manufacturing also relates to the field of elastic bands, whether made into wristbands or head bands. “Elastic bands” in this regard refers not to simple rubber bands but to bands having an inner core of elastic material covered with a fabric, such as a hair band. Usage of the wristbands herein is similar to acupressure devices.

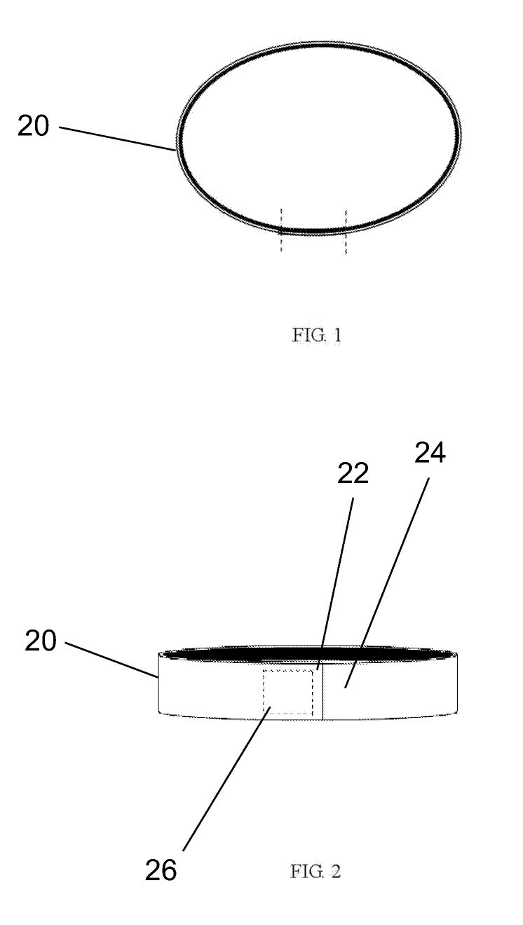

The wristband such as shown in FIGS. 1 and 2 comprises an elongated strip 20 having a first end 22 fixedly connected to a second end 24 to create a continuous loop. The elongated strip is formed of a non-silicone elastic construction and has an exterior surface on which graphics may be printed. The wristband of elongate material non silicone may be made with black neoprene foam; black nylon backing and fused with a white poly cotton front (raw neoprene materials come in rolls of about 87 inches by 55 inches, and thickness ranges from 0.5 mm to 6 mm; begin cut down to sheet size for dye sublimation to 8 and a half by 11 inches, and then printed and cut again to the length or strip size of 8 and half inches long and an approx. width of three-quarters of an inch) finished size; shown coupled; approx. three and a half inches by three-quarters of an inch. The flexible material with its first end fixedly connected to a (overlapping) second end, (shown coupled together by stitching) creating a wristband. Although the drawing does not depict a graphic image, pattern or design, on the surface of the white poly cotton front of the elongate material, it is not limited to be of plain or colorless material. And indeed may take on a variety of shapes and sizes. For instance, graphics may be provided within a region 26 shown in dashed outline.

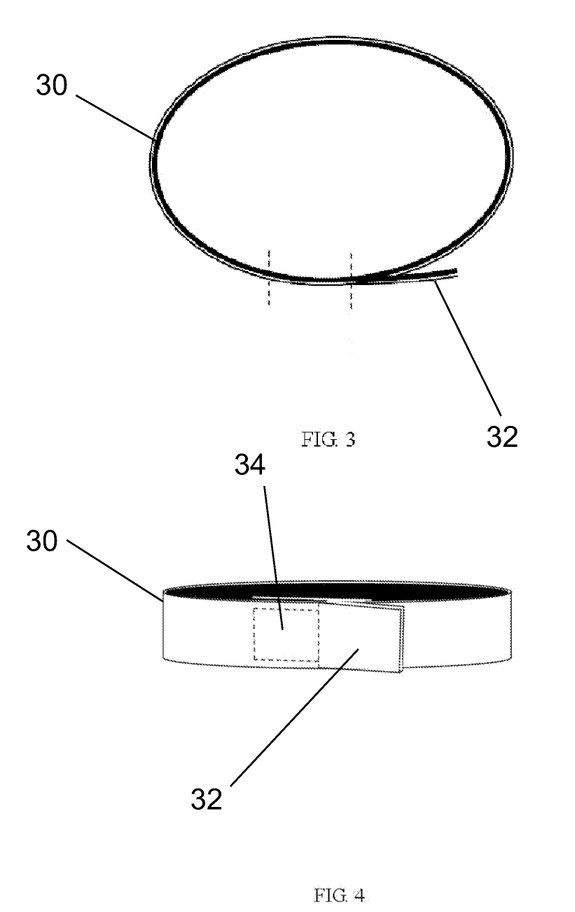

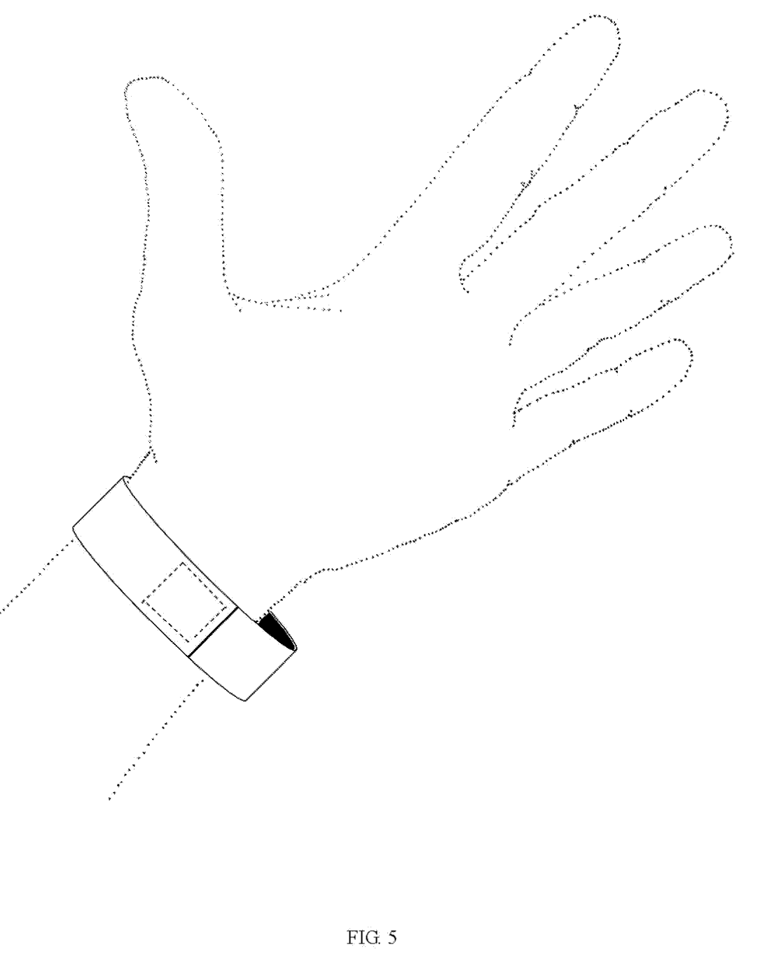

As illustrated in FIGS. 3 and 4, an alternative wristband strip 30 may be constructed from a plurality of flexible material(s), connected in any known manufacturing manner to create a continuous loop (band), and in which part of the flexible material protrudes past the first end fixedly connected to a (overlapping) second end, creating a wristband with a tab 32 (approx. tab size, three eights of an inch by three eights of an inch).

As illustrated in FIGS. 3 and 4, the wristband with tab 32 is depicted as made with black neoprene foam; black nylon backing and fused with a white poly cotton front. Part of the flexible material desirably protrudes past the first end fixedly connected (stitched) to a (overlapping) second end, creating a wristband with the tab 32. Although the drawing does not depict a graphic image, pattern or design, on the surface of the materials, it is not limited to be a plain or a colorless material. And indeed may take on a variety of shapes and sizes. For instance, graphics may be provided within a region 34 shown in dashed outline; A scan bar; QR code bar or tag would be printed on the wristband, and the end user would be able to scan the printed area with a bar code or tag reader, such as a cell phone app. to link (connect) to a website for additional information and or reinforcements.

In a preferred embodiment, graphics such as images and/or printing is provided on the wristband. With the preferred materials mentioned above, dye sublimation is used to imprint the graphics. Sublimation involves first printing on a transfer paper, then heat pressing the paper on to the fabric. The heat press in dye sublimation would be too much heat for a regular rubber band, it would just melt. The poly cotton glued to the neoprene makes the sublimation (printing) work.

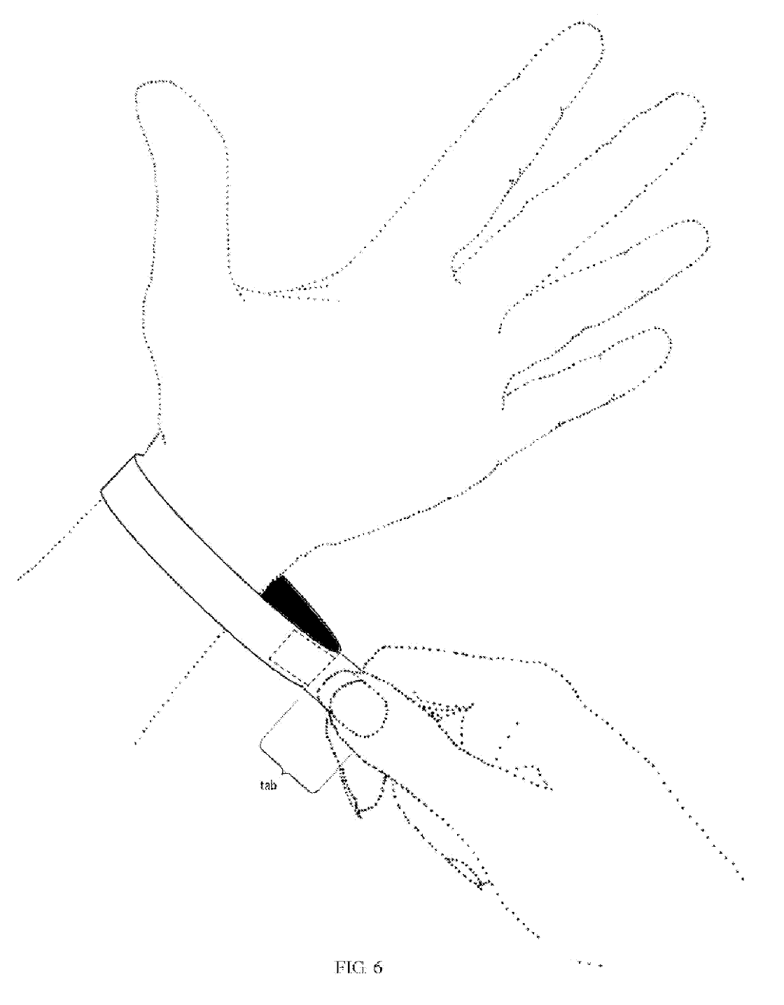

The wristband, as seen in FIG. 5, is to act as a visual reminder, it may be elongated by pulling on the flexible band material (snapping with a popping sound) for adult users or tapping of the wristband for children.

A wristband of elongate material non silicone, as seen in FIG. 6, may be elongated by pulling on the attached tab (adult users). Once tab is released by a user the “thought-stopping”, verbal mantra, reminder goal and/or breathing techniques would commence (again tapping on the wristband for children).

The above exemplary embodiment may include many variations thereof to achieve and/or create additional or alternative features. For example, all kinds of colors, images, photographs, artwork, and design patterns and/or a logo of advertisements can be manufactured on the surface material of the wristband and/or tab, by sublimation, print, embroidery or heat stamp.

The subject of advertisements in this context includes, but is not limited to: animals, mammals, fish, insects; school mascots, school, company, organization or intuition, sports teams, names or logos of same; characters, celebrity likenesses, celebrity causes, i.e. non profits, fundraising; slogans, mantras, or motivational quotes of individuals.

A method of using the wristbands described herein include providing a reminder or suggestion with graphics on the exterior of the strip which provides a visible and apparent tool for practicing a particular task or vice-versa, not doing a certain thing. For instance, a term such as “FOCUS” may be imprinted on the band shown in FIGS. 3 and 4, which reminds the wearer to maintain focus on a particular task, for example. Periodically, the wearer notices the reminder, and stays on task. This periodic reminder may be easier with the tab 32 which provides a physical mnemonic by virtue of the wearer every so often brushing against it. The wearer can also be instructed to pull back the tab 32 and “snap” the wristband periodically as a further reminder to pay attention to the particular message. This audio snap or pop sound also acts as a trigger to aid the user to refocus on the task at hand.

Although the invention has been described and illustrated with a certain degree of particularity, it is understood that the present disclosure has been made only by way of example, and that numerous changes in the combination and arrangement of parts can be resorted to by those skilled in the art without departing from the scope of the invention, as hereinafter claimed.

What is claimed is:

1. A wristband comprising an elongated strip having a first end fixedly connected to a second end to create a continuous loop, the elongated strip being formed of a non-silicone elastic construction and having an exterior surface on which graphics may be printed.

2. The wristband of claim 1, wherein the first end fixedly connects to the second end by a method selected from the group consisting of:
stitches,
glue,
one or more staples,
one or more grommets,
one or more snaps, and
one or more buttons.

3. The wristband of claim 1, wherein the elongated strip is made of a construction selected from the group consisting of:
an elastic band surrounded by fabric, and
black neoprene foam; black nylon backing and fused with a white poly cotton front.

4. The wristband of claim 1, wherein the elongated strip comprises a plurality of lengths joined together.

5. The wristband of claim 1, wherein the elongate overlapping material that forms the tab may be stitched, glued, stapled, grommet, snapped or buttoned for coupling (for manufacturing purposes).

6. The wristband of claim 1, wherein the core comprises a continuous loop, with elongate material protruding past the connection point for the creation of a tab.

7. A method of training a particular behavior, comprising:
wearing an elastic wristband having graphics imprinted on an exterior surface; and
periodically stretching the wristband outward and snapping it back.

8. A method of connecting a printed wristband to a website:
a scan bar; QR code bar or tag would be printed on the wristband, and the end user would be able to scan the printed area with a bar code or tag reader, such as a cell phone app. to link (connect) to a website for additional information.
